(19) United States
(12) Patent Application Publication
(10) Pub. No.: US 2021/0200853 A1
(43) Pub. Date: Jul. 1, 2021

(54) PORTABLE DEVICE IDENTIFIERS DETERMINATION

(71) Applicant: Hewlett-Packard Development Company, L.P., Houston, TX (US)

(72) Inventors: Isaac Lagnado, Houston, TX (US); Danny F Meng, Houston, TX (US)

(21) Appl. No.: 16/065,620

(22) PCT Filed: Apr. 6, 2016
(86) PCT No.: PCT/US2016/026215

§ 371 Date: Jun. 22, 2018

(51) Int. Cl. G06F 21/34; H04L 9/32; G06F 21/31; H04L 29/08

(52) U.S. Cl. CPC G06F 21/34; H04L 9/3234; H04L 67/306; G06F 21/316; H04L 9/3226

(57) ABSTRACT

An example system includes a device identification engine. The device identification engine is to detect a portable computing device based on interaction of a user of the portable computing device with a security device. The device identification engine also is to determine an identifier associated with the portable computing device. The system also includes a user identification engine to determine an identity of the user based on a data structure relating identifiers associated with portable computing devices to identities of users of the portable computing devices.

### BACKGROUND

A device may communicate with a network wirelessly. For example, the network may include a plurality of access points, and the device may send data to and receive data from the access points to communicate with other devices in the network. As used herein, the term “access point” refers to a device that communicates data between a wireless device and a network. The access points may include Wi-Fi base stations, cellular base stations (e.g., evolved Node Bs), or the like. The network may include a local area network (LAN), a wide area network (WAN) (e.g., the Internet), or the like. Alternatively, or in addition, the device may communicate with another device wirelessly. For example, the devices may communicate using a Bluetooth protocol.

### BRIEF DESCRIPTION OF THE DRAWINGS

FIG. 1 is a block diagram of an example system to identify a user of a portable computing device.

FIG. 2 is a block diagram of another example system to identify a user of a portable computing device.

FIG. 3 is a flow diagram of an example method to secure a location against unknown users of portable computing devices.

FIG. 4 is a flow diagram of another example method to secure a location against unknown users of portable computing devices.

FIG. 5 is a block diagram of an example computer-readable medium including instructions that cause a processor to identify and track a user of a portable computing device.

FIG. 6 is a block diagram of another example computer-readable medium including instructions that cause a processor to identify and track a user of a portable computing device.

### DETAILED DESCRIPTION

The device may be a portable computing device. As used herein, the term “portable computing device” refers to a device comprising a processor that can operate while in possession of a moving user. For example, the portable computing device may include a vehicle, a notebook computer, a tablet, a phablet, a smart phone, a personal media player, a speaker, a camera, a smart watch, a wireless headset, wireless earphones, or the like. The portable computing device may be convenient for tracking movement of the user. The portable computing device may often travel with the user, so as the user's location changes, the location of the portable computing device changes as well. In addition, the portable computing device may rarely travel in the possession of another user, so changes in the location of the portable computing device are unlikely to correspond to movement of the other user.

The portable computing device may include hardware or software to determine the location of the portable computing device. However, it may difficult for a third party to track the location of the portable computing device without the consent or cooperation of the user. The user may be unwilling to provide such consent or cooperation, particularly if the user is engaged malicious or illicit activities. Moreover, there may be legal restrictions on modifying operation of the portable computing device without the consent or cooperation of the user. Accordingly, tracking of users engaged in malicious or illicit activity could be improved by determining the location of the user without their consent or cooperation.

The portable computing device may have a unique identifier that may be transmitted when wirelessly connecting with another device, such as an access point. The identifier may include a media access control (MAC) address, a system identifier, an international mobile subscriber identity (IMSI), an international mobile station equipment identity (IMEI), a mobile equipment identifier (MEID), an electronic serial number (ESN), or the like. The portable computing device may also, or instead, transmit the unique identifier when searching for another device to which to connect. Thus, the portable computing device may be tracked based on the unique identifier without modifying the operation of the portable computing device or needing consent or cooperation of the user. However, determining the unique identifier and tracking its location does not provide any information about the user of the portable computing device. For example, a malicious or illicit activity may be traced back to the unique identifier associated with the portable computing device of the perpetrator, but the perpetrator may remain unknown. Accordingly, tracking the user could be improved by identifying the user based on the identifier of the user's portable computing device.

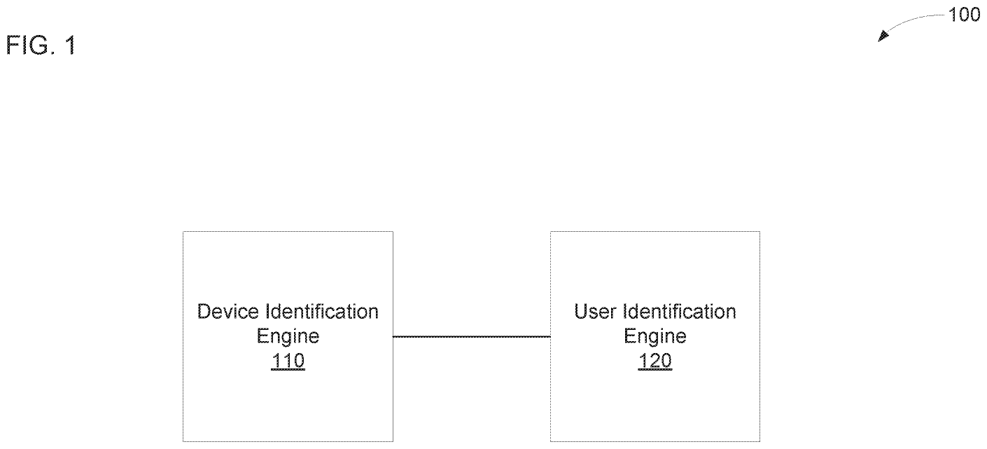

FIG. 1 is a block diagram of an example system 100 to identify a user of a portable computing device. The system 100 may include a device identification engine 110. As used herein, the term “engine” refers to hardware (e.g., a processor, such as an integrated circuit or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or executed or interpreted by a processor), or hardware and software hosted at hardware. The device identification engine 110 may include a transceiver, or the device identification engine 110 may be communicatively coupled to a transceiver. As used herein, the term “transceiver” refers to hardware (e.g., analog or digital circuitry) to modulate or demodulate electromagnetic waves. The transceiver may, but does not necessarily, include an antenna.

The device identification engine 110 may detect a portable computing device based on interaction of a user with a security device. As used herein, the term “security device” refers to a device to detect the presence of a person or to restrict access of the person to particular location. For example, the security device may include a doorbell, a card reader (e.g., a bar code reader, a radio frequency reader, etc.), an access panel (e.g., requiring a pin, biometric information, etc. to receive access), a camera (e.g., a video camera, a still image camera, etc.), a motion sensor, or the like. The device identification engine 110 may detect the portable computing device by detecting an electromagnetic transmission by the portable computing device. In an example, the device identification engine 110 may monitor for electromagnetic transmissions from the portable computing device based on the interaction of the user with the security device.

The device identification engine 110 may determine an identifier associated with the portable computing device. The identifier may be a unique identifier transmitted by the portable computing device, for example, when connecting with another device (e.g., an access point) or searching for another device with which to connect. The device identification engine 110 may receive transmissions from the portable computing device and extract the identifier from the received transmissions. The device identification engine 110 may be an intended recipient of the transmissions; the device identification engine 110 may eavesdrop on transmissions intended for another device; the transmissions may be broadcasts; or the like.

The system 100 also may include a user identification engine 120. The user identification engine 120 may determine an identity of the user based on a data structure relating identifiers associated with portable computing devices to identities of users of the portable computing devices. For example, the data structure may be stored in a persistent storage device local to the system 100, or the user identification engine 120 may communicate with a remote system (not shown) that includes a persistent storage device to store the data structure. The identity of the user may include a name of the user, a number associated with the user (e.g., an employee number; a government identification number, such as a social security number or driver's license number; etc.), an employer of the user, or the like.

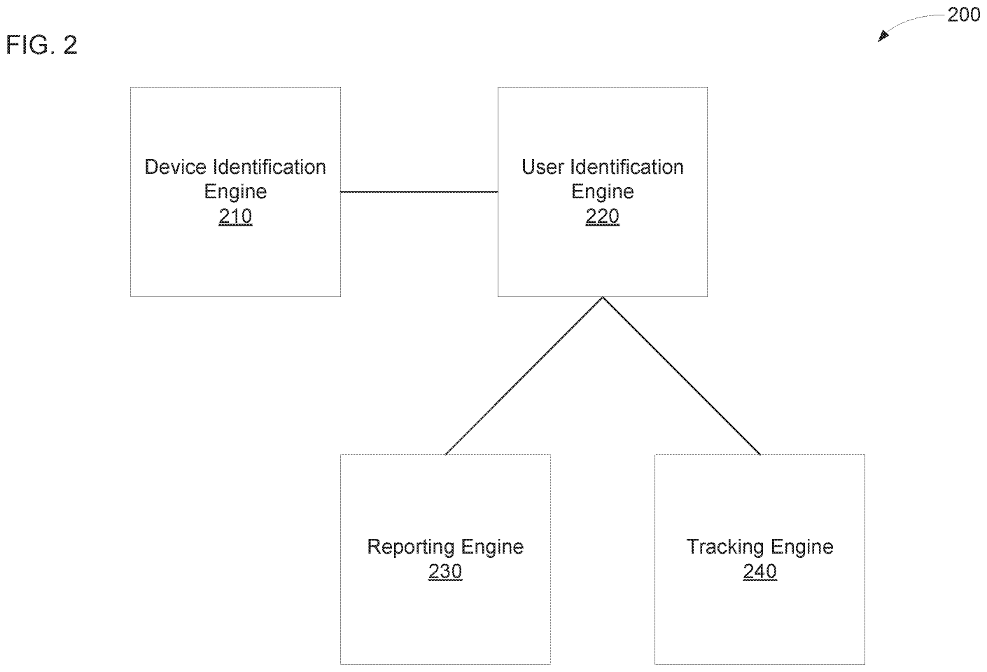

FIG. 2 is a block diagram of another example system 200 to identify a user of a portable computing device. The system 200 may include a device identification engine 210. The device identification engine 210 may detect a portable computing device based on interaction of a user of the portable computing device with a security device. In some examples, the security device may detect the presence of the user, and the device identification engine 210 may detect the portable computing device based on the security device detecting the user. For example, the user may push a doorbell, move a card in front of a card reader, provide input to an access panel, produce motion detected by a camera or motion sensor, or the like.

The device identification engine 210 may detect the portable computing device actively or passively. In an example, the device identification engine 210 may detect the portable computing device by receiving a broadcast querying for nearby devices (e.g., a Wi-Fi probe request broadcast by the portable computing device, a Bluetooth inquiry broadcast by the portable computing device, etc.), by receiving a transmission from the portable computing device that is addressed to a device other than the device identification engine 210, by initiating a connection with the portable computing device (e.g., associating with the portable computing device, authenticating with the portable computing device, pairing with the portable computing device, entering a connected state with the portable computing device, etc.), or the like. The device identification engine 210 may announce itself to the portable computing device (e.g., by transmitting Wi-Fi beacon frames or Bluetooth inquiries), may include an access point connected to a network (e.g., the Internet) capable of providing network connectivity to the portable computing device, may only receive transmissions and not transmit itself, or the like.

The device identification engine 210 may determine an identifier associated with the portable computing device based on the detected transmission. For example, the identifier may be included at a predetermined location in the transmission. The device identification engine 210 may extract the identifier from the predetermined location in the transmission. The device identification engine 210 may distinguish the portable computing device of the user from other nearby portable computing device. For example, the device identification engine 210 may distinguish the portable computing device based on the location of the portable computing device (e.g., as detected based on a directional antenna, as detected based on a plurality of antennas, etc.). Alternatively, or in addition, the device identification engine 210 may distinguish the portable computing device based on at least one portable computing device being associated with the user, based on the other portable computing devices being associated with other known users, based on a signal strength received from the portable computing device, or the like.

The system 200 may include a user identification engine 220. The user identification engine 220 may determine the identity of the user based on a data structure relating identifiers associated with portable computing devices to identities of users of the portable computing device. The data structure may be populated by an operator of the system 200, or the user identification engine 220 may populate the data structure. For example, the user identification engine 220 may determine the user's identity based on the interaction between the user and the security device (e.g., based on a card provided to a card reader by the user, an image of the user, a pin provided by the user, biometric information received from the user, etc.). In an example, the user identification engine 220 may determine the user's identity during an initial interaction between the user and the security device. The user identification engine 220 may confirm the identity of the user based on the identifier of the portable computing device during subsequent interactions. If multiple unknown portable computing devices are detected during the initial interaction, the user identification engine 220 may analyze a plurality of initial interactions to determine which portable computing device is associated with each user.

The system 200 may include a reporting engine 230. The reporting engine 230 may indicate an identity of the user to an operator of the security device. For example, the operator may be a homeowner, security personnel (e.g., monitoring a security camera, operating an access control device, etc.), or the like. The reporting engine 230 may receive a response from the operator to allow access to the user, and the reporting device 230 may indicate to the security device to allow access to the user. In an example, the security device may be a doorbell able to unlock a door, and the reporting device 230 may instruct the doorbell to unlock the door based on receiving the response from the operator. Similarly, a card reader or an access panel may be associated with a door, barrier, or the like that may unlock or open based on the indication from the reporting device 230. Alternatively, or in addition, the reporting engine 230 may determine without operator input whether to allow access based on operator-specified rules indicating, for example, who can have access to what areas and when.

In some examples, the user identification engine 220 may determine based on the data structure whether the portable computing device is unknown. For example, the data structure may not contain the identifier of the portable computing device or may not contain a user associated with the identifier. The system 200 may include a tracking engine 240, which may store the identifier based on the determination that the portable computing device is unknown. For example, the tracking engine 240 may store the identifier in a persistent storage device. The tracking engine 240 may also store a timestamp indicating when the portable computing device was detected or when the user interacted with the security device, a location of the security device with which the user interacted or the transceiver that detected the portable computing device, data from the security device (e.g., an image from a security camera, the data read by a card reader, the user input into the access panel, etc.), or the like.

In some examples, the user identification engine 220 may perform a security response or instruct the security device or another security device to perform a security response based on the user being unknown. As used herein, the term “performing a security response” refers to a processor capturing information about a user of the portable computing device or deterring the presence of the user of the portable computing device or causing another component to do so. Capturing information about the user of the portable computing device may include capturing an image of the user, e.g., using a camera. Capturing information may include storing an indication of the identifier associated with the portable computing device, storing an indication of the location at which the portable computing device was detected, or the like, e.g., in a persistent storage device. Deterring the presence of the user may include turning on a light, e.g., a light that would illuminate the user. Deterring the presence of the user may include sounding an alarm. For example, speakers may be instructed to play a loud, annoying, or traditional alarm noise audible to the user. Deterring the presence of the user may include ostentatiously capturing an image of the user. For example, a camera may capture an image using a flash; the camera may aim noisily at the user; the camera may display a light, such as a flashing red light, indicating the camera is capturing an image of the user; or the like. The user identification engine 220 may also, or instead, transmit a notification of the location at which the portable computing device was detected to a predetermined recipient, such as the operator of the security device. The operator may then manually deter or capture information about the user of the portable computing device.

The user may properly authenticate with the security device (e.g., inserts a correct pin, provides proper biometric information, presents a card that authenticates, etc.), but the user identification engine 220 may determine the user's portable computing device is unknown. Based on the portable computing device being unknown, the user identification engine 220 may indicate to the security device to request additional authentication from the user. In an example, the security device may indicate to the user identification engine 220 that the user has authenticated with the security device. The user identification engine 220 may detect a plurality of portable computing devices near the security device. The user identification engine 220 may determine that none of the plurality of portable computing devices is associated with the user. The user identification engine 220 may indicate to the security device to request additional authentication based on none of the plurality of portable computing devices being associated with the user.

The tracking engine 240 may continue to track the locations of known or unknown users of portable computing devices as they move within a monitored area. For example, the tracking engine 240 may be communicatively coupled to a plurality of transceivers (e.g., access points, transceivers not connected to a network, transceivers that monitor transmissions without connecting to portable computing devices, etc.), and the tracking engine 240 may determine the user's location based on the plurality of transceivers. For example, the tracking engine 240 may determine a coarse location based on which transceivers detect the user. Alternatively, or in addition, the tracking engine 240 may determine a fine location based on triangulation by some or all of the plurality of transceivers, based on measurements by directional antennas, or the like. Accordingly, the user's location can be tracked without requiring additional interaction between the user and security devices.

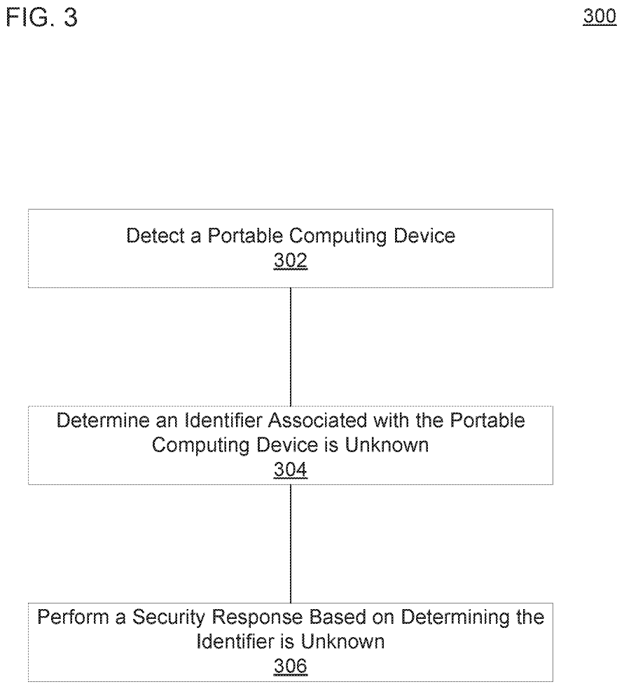

FIG. 3 is a flow diagram of an example method 300 to secure a location against unknown users of portable computing devices. A processor may perform the method 300. At block 302, the method 300 may include detecting a portable computing device. For example, detecting the portable computing device may include receiving a transmission from the portable computing device, such as an electromagnetic transmission. Detecting the portable computing device may include passively listening for transmissions or actively inducing the portable computing device to make the transmission. Detecting the portable computing device may also, or instead, include detecting a user of the portable computing device. Transmissions may be listened for actively or passively based on detecting the user.

Block 304 may include determining an identifier associated with the portable computing device is unknown. For example, the portable computing device may include the identifier in a predetermined location of the detected transmission. Determining the identifier may include extracting the identifier from the predetermined location of the detected transmission. Determining the identifier is unknown may include comparing the identifier to identifiers of known portable computing devices. The identifier may be unknown if it does not match an identifier of a known portable computing device. Alternatively, or in addition, determining the identifier is unknown may include comparing the identifier to a set of unknown identifiers and finding a match.

At block 306, the method 300 may include performing a security response based on determining the identifier is unknown. The security response may include capturing information about the user of the portable computing device, deterring the presence of the user of the portable computing device, or the like. For example, capturing information may include storing the identifier or additional information determined in blocks 302 or 304. Alternatively, or in addition, capturing information may include instructing a security device, such as a camera, a microphone, etc., to capture information about the user. Deterring the presence of the user may include instructing a security device to deter the presence of the user. Capturing information or deterring the presence of the user may include instructing an operator to capture information or deter the presence of the information. Referring to FIG. 1, for example, the device identification engine 110 may perform blocks 302 or 304, and the user identification engine 120 may perform blocks 304 or 306.

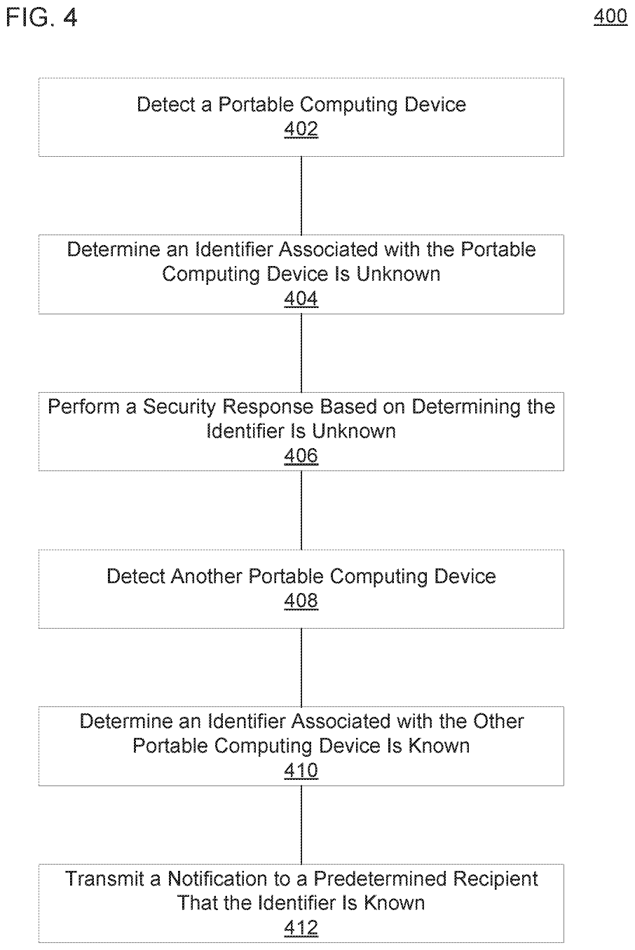

FIG. 4 is a flow diagram of another example method 400 to secure a location against unknown users of portable computing devices. A processor may perform the method 400. At block 402, the method 400 may include detecting a portable computing device. For example, detecting the portable computing device may include periodically or continuously monitoring for portable computing devices. Monitoring for the portable computing devices may include monitoring for electromagnetic transmissions at predetermined frequencies. Alternatively, or in addition, detecting the portable computing device may include detecting a user of the portable computing device and monitoring for the portable computing device based on detecting the user. Detecting the user may include detecting the user with a camera, a motion sensor, a card reader, an access panel, a doorbell, or the like.

At block 404, the method 400 may include determining an identifier associated with the portable computing device is unknown. The identifier may include a MAC address, a system identifier, an IMSI, an IMEI, an MEID, an ESN, or the like. For example, determining the identifier may include extracting the identifier from a transmission using a short-range protocol (e.g., a Wi-Fi transmission, a Bluetooth transmission, etc.), a long-range protocol (e.g., a cellular transmission, etc.), or the like. In some examples, detecting the portable computing device or determining the identifier may include inducing the portable computing device to transmit the identifier. For example, detecting the portable computing device or determining the identifier may include pretending to be or actually being an access point or another device (e.g., by transmitting a beacon frame, an inquiry, etc.). Alternatively, or in addition, detecting the portable computing device or determining the identifier may include intercepting transmissions intended for another recipient. In some examples, detecting the portable computing device or determining the identifier may include doing so without connecting to the portable computing device (e.g., without associating with the portable computing device, authenticating with the portable computing device, pairing with the portable computing device, entering a connected state with the portable computing device, etc.).

Block 406 may include performing a security response based on determining the identifier is unknown. Performing the security response may include performing an automatic security response or instructing an operator to perform manual security response. The security response may include capturing information about the user of the portable computing device or deterring the presence of the user of the portable computing device. Automatically capturing information about the user of the portable computing device may include storing the identifier, storing an indication of the location or time at which the portable computing device was detected, capturing an image of the user, or the like. Automatically deterring the presence of the user may include turning on a light, sounding an alarm, ostentatiously capturing an image of the user, or the like. Manually performing a security response may include transmitting a notification to a predetermined recipient, such as an operator, security personnel, etc., of the location at which the portable computing device was detected. Manually performing the security response may include indicating to the predetermined recipient to capture information about the user, deter the presence of the user, etc.

At block 408, the method 400 may include detecting another portable computing device. For example, detecting the other portable computing device may include detecting a transmission of the portable computing device or detecting a user of the portable computing device. At block 410, the method 400 may include determining an identifier associated with the other portable computing device is known. For example, determining the identifier is known may include extracting the identifier from the transmission, comparing the identifier to identifiers of known portable computing devices, and finding a match. In an example, a data structure may contain the identifiers of known portable computing devices, and the identifier may be compared to elements of the data structure.

Block 412 may include transmitting a notification to a predetermined recipient that the identifier is known. In some examples, the data structure may associate each identifier with an identity of the user, and transmitting the notification may include transmitting the identity of the user in the notification. The identity of the user may include a name of the user, a number associated with the user (e.g., an employee number; a government identification number, such as a social security number or driver's license number; etc.), an employer of the user, or the like. Alternatively, transmitting the notification may include indicating the user is known without indicating the identity. The predetermined recipient may be an operator of a security device, such as a homeowner, security personnel, or the like. The notification may indicate the predetermined recipient should allow access to the user. For example, the notification may indicate to a homeowner that a person ringing a doorbell is known and the door should be opened. Alternatively, or in addition, the notification may simply alert the predetermined recipient to the presence of the known user. In an example, the device identification engine 210 of FIG. 2 may perform blocks 402, 404, 408, or 410, the user identification engine 220 may perform blocks 404, 406, or 410, the reporting engine 230 may perform block 412, and the tracking engine 240 may perform block 406.

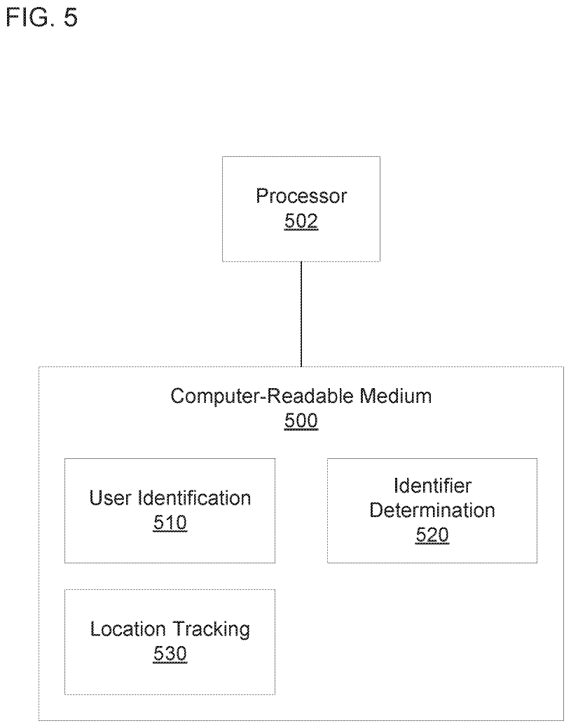

FIG. 5 is a block diagram of an example computer-readable medium 500 including instructions that, when executed by a processor 502, cause the processor 502 to identify and track a user of a portable computing device. The computer-readable medium 500 may be a non-transitory computer readable medium, such as a volatile computer readable medium (e.g., volatile RAM, a processor cache, a processor register, etc.), a non-volatile computer readable medium (e.g., a magnetic storage device, an optical storage device, a paper storage device, flash memory, read-only memory, non-volatile RAM, etc.), and/or the like. The processor 502 may be a general purpose processor or special purpose logic, such as a microprocessor, a digital signal processor, a microcontroller, an ASIC, an FPGA, a programmable array logic (PAL), a programmable logic array (PLA), a programmable logic device (PLD), etc.

The computer-readable medium 500 may include a user identification module 510. As used herein, a “module” (in some examples referred to as a “software module”) is a set of instructions that when executed or interpreted by a processor or stored at a processor-readable medium realizes a component or performs a method. The user identification module 510 may include instructions that cause the processor 502 to identify a user of a portable computing device based on interaction of the user with a security device. In an example, the security device may require that the user present uniquely identifying information, e.g., to gain access to a restricted area. The user identification module 510 may cause the processor 502 to receive the uniquely identifying information from the security device. Alternatively, or in addition, the security device may capture identifying information from the user without presentation by the user, and the user identification module 510 may cause the processor to receive the identifying information from the security device.

The computer-readable medium 500 may include an identifier determination module 520. The identifier determination module 520 may cause the processor 502 to determine an identifier associated with the portable computing device. The identifier determination module 520 may cause the processor 502 determine the identifier by receiving a transmission by the portable computing device and extracting the identifier from the received transmission. The identifier determination module 520 may cause the processor 502 to monitor for transmissions by the portable computing device based on identifying the user. Alternatively, or in addition, the identifier determination module 520 may cause the processor 502 to monitor for transmissions continuously or periodically and determine the identifier based on a transmission proximate in time (e.g., before, simultaneous with, or after) with identifying the user.

The computer-readable medium 500 may include a location tracking module 530. The location tracking module 530 may cause the processor 502 to track a location of the user based on the identifier associated with the portable computing device. For example, the location tracking module 530 may cause the processor 502 to be communicatively coupled to a plurality of transceivers (e.g., access points, transceivers not connected to a network, transceivers that monitor transmissions without connecting to portable computing devices, etc.) or a plurality of antennas (e.g., directional antennas, non-directional antennas, etc.). The plurality of transceivers or antennas may detect transmissions by the portable computing device containing the identifier. The location tracking module 530 may cause the processor 502 to determine the location of the user based on which transceiver or antenna detected the transmission, based on detection by multiple of the plurality of transceivers or antennas (e.g., based on signal strength, based on receipt time, etc.), or the like. Referring to FIG. 2, the user identification module 510, when executed by the processor 502, may realize the user identification engine 220, for example. The identifier determination module 520, when executed by the processor 502, may realize the device identification engine 210, for example. The location tracking module 530, when executed by the processor 502, may realize the tracking engine 240, for example.

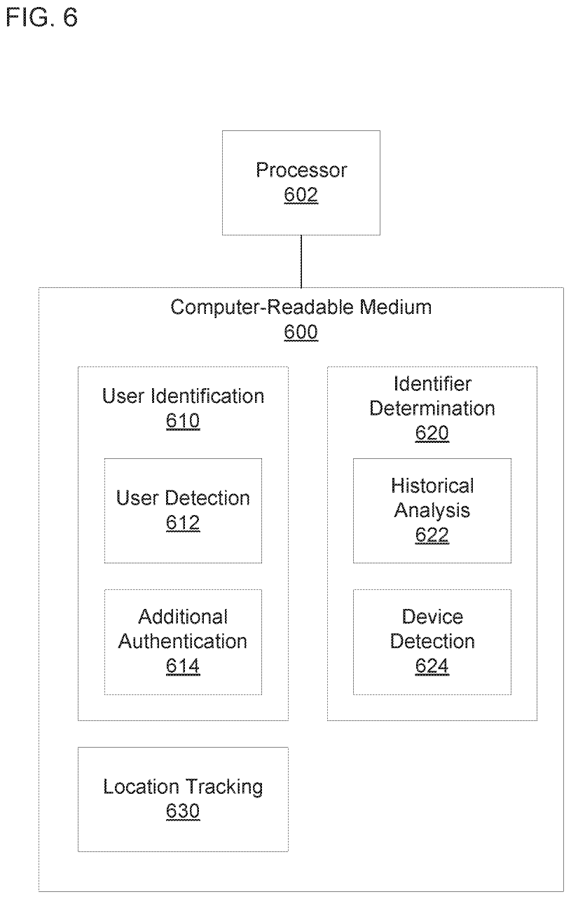

FIG. 6 is a block diagram of an example computer-readable medium 600 including instructions that, when executed by a processor 602, cause the processor 602 to identify and track a user of a portable computing device. The computer-readable medium 600 may include a user identification module 610. The user identification module 610 may cause the processor 602 to identify a user of a portable computing device based on interaction of the user with a security device. The security device may include a doorbell, a card reader, an access panel, a camera, a motion sensor, or the like. For example, the user may present uniquely identifying information to the card reader (e.g., a card containing a unique identifier, etc.), the access panel (e.g., a unique pin, unique biometric information, etc.), or the like. Identifying information may be captured by the camera (e.g., an image, etc.), the motion sensor (e.g., a thermal signature, etc.), the doorbell (e.g., biometric information, etc.), or the like.

The computer-readable medium 600 may include an identifier determination module 620. The identifier determination module 620 may cause the processor 602 to determine an identifier associated with the portable computing device. The identifier determination module 620 may cause the processor 602 to induce the portable computing device to provide the identifier by pretending to be or actually serving as an access point or another device or by communicatively coupling to a transceiver pretending to be or actually serving as an access point or another device. Alternatively, or in addition, the identifier determination module 620 may cause the processor 602 to eavesdrop on communications by the portable computing device or to communicatively couple to a transceiver eavesdropping on communications by the portable computing device.

In the illustrated example, the identifier determination module 620 may include a historical analysis module 622. The historical analysis module 622 may cause the processor 602 to determine the identifier associated with the portable computing device based on comparing a plurality of interactions of the user with the security device. For example, there may be multiple unknown portable computing devices present the first time the user interacts with the security device. However, different sets of portable computing devices may be present each time the user interacts with the security device. Accordingly, the historical analysis module 622 may cause the processor 602 to determine which portable computing device is detected for many or all of the user's interactions with the security device. Because the user may not always carry the portable computing device or the portable computing device may not always make a transmission, the historical analysis module 622 may cause the processor 602 to apply a threshold to determine which identifier is associated with the user (e.g., a number or percentage of detections with user interaction with the security device, a number or percentage of detections with no user interaction, a percentage that varies by number of interactions or non-interactions, etc.). The identifier determination module 620 may also, or instead, cause the processor 602 to determine the identifier associated with the user based on excluding portable computing devices that are already associated with another user, separation in time between detection of the portable computing device and interaction with the security device, location of the portable computing device (e.g., as detected by directional antennas, signal strength or delay between a plurality of antennas, etc.), or the like.

The computer-readable medium 600 may include a location tracking module 630. The location tracking module 630 may cause the processor 602 to track a location of the user based on the identifier associated with the portable computing device. It may be expensive to install security devices at numerous locations, and the security devices may restrict the flow of people at those locations. The location tracking module 630 may cause the processor 602 to store a record of which users are at various locations without requiring additional security devices or restricting the flow of users. Moreover, the location tracking module 630 may cause the processor 602 to leverage existing access points, transceivers, or antennas to track the user, further reducing cost. The location tracking module 630 may cause the processor 602 to store the location of the transceiver or antenna that detected the portable computing device, a location computed based on the transceivers or antennas that detected the portable computing device, data usable to compute the location (e.g., signal strength, timing or delay, etc.), or the like. The location tracking module 630 may cause the processor 602 to store a time at which the portable computing device was detected with the location. The location tracking module 630 may cause the processor 602 to store every time the portable computing device is detected even if at the same location, periodically store the location if the location does not change, store the first and last time the portable computing device was detected based on an inactivity timer, or the like.

The user identification module 610 may cause the processor 602 to detect an interaction purportedly of the user with the security device in which the portable computing device is not detected. For example, the user identification module 610 may include a user detection module 612, and the identifier determination module 620 may include a device detection module 624. The user detection module 612 may cause the processor 602 to determine the user has interacted with the security device, for example, by receiving an indication of the interaction from the security device. The user detection module 612 may cause the processor 602 to alert the identifier determination module 620 to the detection. The identifier determination module 620 may cause the processor 602 to determine whether a known identifier is associated with the user. If there is no known identifier associated with the user, the identifier determination module 620 may cause the processor 602 to determine whether to associate an unknown identifier with the user (e.g., using the historical analysis module 622). If there is a known identifier associated with the user, the device detection module 624 may cause the processor 602 to detect whether the portable computing device associated with the user is present (e.g., by detecting a transmission containing the identifier).

The device detection module 624 may cause the processor 602 to indicate to the user identification module 610 whether the portable computing device is detected. The user identification module 610 may include an additional authentication module 614. If the portable computing device is not detected, the additional authentication module 614 may cause the processor 602 to instruct the security device to request additional authentication from the user. In some examples, the additional authentication may be different from the authentication provided during the initial interaction with the security device. For example, the security device may request a different input, such as a pin or a different pin, a birthdate, a social security or employee number, different biometric information, or the like. Alternatively, or in addition, the additional authentication module 614 may cause the processor 602 to alert a predetermined recipient, such as security personnel that the portable computing device was not detected. The additional authentication module 614 may cause the processor 602 to transmit identifying information for the user to the predetermined recipient, such as a name of the user, a picture of the user, or the like. In an example, the user identification module 610, user detection module 612, additional authentication module 614, or historical analysis module 622, when executed by the processor 602, may realize the user identification engine 220 or reporting engine 230 of FIG. 2; the identifier determination module 620, historical analysis module 622, or device detection module 624, when executed by the processor 602, may realize the device identification engine 210; and the location tracking module 630, when executed by the processor 602, may realize the tracking engine 240.

The above description is illustrative of various principles and implementations of the present disclosure. Numerous variations and modifications will become apparent to those skilled in the art once the above disclosure is fully appreciated. Accordingly, the scope of the present application should be determined only by the following claims.

What is claimed is:

1. A system, comprising:
a device identification engine to:
detect a portable computing device based on interaction of a user of the portable computing device with a security device, and
determine an identifier associated with the portable computing device; and
a user identification engine to determine an identity of the user based on a data structure relating identifiers associated with portable computing devices to identities of users of the portable computing devices.

2. The system of claim 1, further comprising a reporting engine to indicate the identity of the user to an operator of the security device.

3. The system of claim 2, wherein the reporting engine is to:
receive a response from the operator to allow access to the user, and
indicate to the security device to allow access to the user.

4. The system of claim 1, wherein the device identification engine is to detect the portable computing device and determine the identifier without associating with the portable computing device.

5. The system of claim 1, wherein the user identification engine is to determine that the user is unknown based on the identifier, and wherein the system further comprises a tracking engine to store the identifier based on the determination that the portable computing device is unknown.

6. A method, comprising:
detecting, using a processor, a portable computing device;
determining, using the processor, an identifier associated with the portable computing device is unknown; and
performing, using the processor, a security response based on determining the identifier is unknown,
wherein the security response comprises at least one of capturing information about a user of the portable computing device and deterring presence of the user of the portable computing device.

7. The method of claim 6, wherein deterring the presence of the user of the portable computing device comprises at least one of turning on a light, sounding an alarm, and ostentatiously capturing an image of the user.

8. The method of claim 6, wherein capturing the information about the user of the portable computing device comprises at least one of capturing an image of the user of the portable computing device and storing the identifier and an indication of a location at which the portable computing device was detected.

9. The method of claim 8, wherein the security response comprises transmitting a notification of the location at which the portable computing device was detected to a predetermined recipient.

10. The method of claim 6, further comprising:
determining an identifier associated with another portable computing device is known; and
transmitting a notification to a predetermined recipient that the identifier associated with the other portable computing device is known.

11. A non-transitory computer-readable medium comprising instructions that, when executed by a processor, cause the processor to:
identify a user of a portable computing device based on interaction of the user with a security device;
determine an identifier associated with the portable computing device; and
track a location of the user based on the identifier associated with the portable computing device.

12. The computer-readable medium of claim 11, wherein the security device comprises at least one of a camera, a card reader, and an access panel.

13. The computer-readable medium of claim 11, wherein the instructions, when executed by a processor, cause the processor to determine the identifier associated with the portable computing device based on comparing a plurality of interactions of the user with the security device.

14. The computer-readable medium of claim 11, wherein the instructions, when executed by a processor, cause the processor to:
detect an interaction purportedly of the user with the security device in which the portable computing device is not detected;
cause the security device to request additional authentication.

15. The computer-readable medium of claim 11, wherein the instructions, when executed by a processor, cause the processor to track the user based on access points detecting the location of the user.
